(19) United States
(12) Patent Application Publication
(10) Pub. No.: US 2011/0177348 A1
(43) Pub. Date: Jul. 21, 2011

(54) COATING METHOD AND COATED ARTICLE OBTAINED BY THE SAME

(75) Inventors: Shuji Yomo, Aichi-ken (JP); Kazuyuki Tachi, Aichi-ken (JP); Kazuyuki Kuwano, Aichi-ken (JP)

(73) Assignee: TOYOTA JIDOSHA KABUSHIKI KAISHA, Toyota-shi, Aichi (JP)

(21) Appl. No.: 13/120,675

(22) PCT Filed: Sep. 18, 2009
(86) PCT No.: PCT/JP2009/066859

§ 371 Date: Mar. 24, 2011

(30) Foreign Application Priority Data
Sep. 30, 2008 (JP) 2008-253945

(51) Int. Cl. B32B 17/10; B32B 15/04; B32B 15/08; B32B 29/00; B32B 27/00; B05D 1/36; B05D 3/02

(52) U.S. Cl. 428/441; 428/457; 428/426; 428/537.1; 428/537.5; 428/461; 428/511; 427/372.2

(57) ABSTRACT

A coating method is a method for forming a laminated coating film including a lowermost layer formed on a base material, at least one intermediate layer formed on the lowermost layer, and an uppermost layer formed on the intermediate layer, and the coating method comprises the steps of:
preparing a thermosetting coating material as a lowermost layer-coating material for forming the lowermost layer, preparing a thermosetting coating material as an intermediate layer-coating material for forming the intermediate layer, wherein at least one thermosetting coating material for the intermediate layer is a thermosetting coating material containing a base resin having a glass transition temperature of 5° C. or less, and preparing a thermosetting coating material as an uppermost layer-coating material for forming the uppermost layer,
forming an uncured laminated coating film by applying the lowermost layer-, the intermediate layer- and the uppermost layer-coating materials on the base material in a wet-on-wet manner, and
curing the lowermost layer-, the intermediate layer- and the uppermost layer-coating materials by subjecting the uncured laminated coating film to a heat treatment.

### TECHNICAL FIELD

The present invention relates to a coating method in which three or more kinds of coating materials are applied in a wet-on-wet manner and then baked, and to a coated article obtained by the same.

### BACKGROUND ART

When a laminated coating film is formed by a coating method in which three or more kinds of coating materials are applied in a wet-on-wet manner and then baked, there has been a conventionally-used method by which the laminated coating film as a whole is cured. In this method, thermosetting coating materials for forming layers constituting a laminated coating film are selected so that all the layers can be cured at the same heating temperature after all the coating materials are applied. However, the conventional coating method has a problem that the obtained laminated coating film is inferior in surface texture and gloss to that obtained by baking a lowermost layer, and then applying and baking coating materials for forming an intermediate layer and an uppermost layer. In this connection, various methods have been proposed to improve the surface texture and the gloss of a laminated coating film.

For example, Japanese Unexamined Patent Application Publication No. 2002-35679 (PTL 1) discloses a method for forming a coating film in which an intermediate coating material, a base coating material and a clear coating material are sequentially applied to an electrodeposition-coated base material, and then the three layers are simultaneously cured by baking. In this method, an excellent finished appearance can be achieved by using the coating materials that, in a state of containing 90% by mass non-volatile content, satisfy the following conditions: the intermediate coating material the base coating material≧the clear coating material in terms of minimum viscosity with respect to temperature, and the intermediate coating material≦the base coating material the clear coating material in terms of curing start temperature.

Meanwhile, Japanese Unexamined Patent Application Publication No. 2005-177680 (PTL 2) discloses a coating method in which, when an intermediate coating material, a base coating material for top coating and a clear coating material for top coating are applied in a wet-on-wet manner and then simultaneously baked, the intermediate coating film is cured prior to the curing of the top coating films, by taking an advantage of the difference in curing rate. By this coating method, the reflection can be certainly ensured.

However, a Wa value (wavelength <0.3 mm) of, for example, 15 or less, which is determined by a wave scan, is required for the appearance quality of automobiles, which are typical products in the coating industry. The conventional coating methods can achieve a Wa value of about 20, but have difficulty in achieving a Wa value of 15 or less.

### CITATION LIST

### Patent Literature

[PTL 1] Japanese Unexamined Patent Application Publication No. 2002-35679
[PTL 2] Japanese Unexamined Patent Application Publication No. 2005-177680

### SUMMARY OF INVENTION

### Technical Problem

The present invention has been made in view of the above-described problems of the conventional techniques. An object of the present invention is to provide a coating method capable of obtaining a laminated coating film having an uppermost layer with less surface unevenness, even when three or more kinds of coating materials are applied in a wet-on-wet manner and baked to cure all the layers for ensuring a high durability or the like. Another object of the present invention is to provide a coated article that is obtained by the same and excellent in appearance quality.

### Solution to Problem

The present inventors have earnestly studied to achieve the above object, and consequently revealed the following fact in the case of applying three or more kinds of thermosetting coating materials in a wet-on-wet manner and then coating them by baking. Specifically, when at least one of the layers (intermediate layers) between the uppermost layer and the lowermost layer is formed by using a thermosetting coating material containing a base resin having a low glass transition temperature (Tg), the fluidity of the laminated coating film is ensured even after the uppermost layer is cured and the fluidity thereof significantly decreases, and thereby the formation of unevenness due to the shrinkage of the laminated coating film can be minimized. Accordingly, a laminated coating film excellent in appearance quality (for example, one having a Wa value of 15 or less, and preferably 10 or less) can be obtained even when baking is performed after applying three or more kinds of coating materials in a wet-on-wet manner. This discovery has led the inventors to complete the present invention.

Specifically, the coating method of the present invention is a coating method for forming a laminated coating film including a lowermost layer formed on a base material, at least one intermediate layer formed on the lowermost layer, and an uppermost layer formed on the intermediate layer, and the coating method comprises the steps of:

preparing a thermosetting coating material as a lowermost layer-coating material for forming the lowermost layer, preparing a thermosetting coating material as an intermediate layer-coating material for forming the intermediate layer, wherein at least one thermosetting coating material for the intermediate layer is a thermosetting coating material containing a base resin having a glass transition temperature of 5° C. or less, and preparing a thermosetting coating material as an uppermost layer-coating material for forming the uppermost layer,

forming an uncured laminated coating film by applying the lowermost layer-, the intermediate layer- and the uppermost layer-coating materials on the base material in a wet-on-wet manner, and

curing the lowermost layer-, the intermediate layer- and the uppermost layer-coating materials by subjecting the uncured laminated coating film to a heat treatment.

In the coating method of the present invention, a coating material having a weight loss percentage of 0.5% by mass or less at a curing temperature thereof is preferably used as the uppermost layer-coating material. Moreover, a coating material having a weight loss percentage of 0.5% by mass or less at a curing temperature of the uppermost layer-coating material is preferably used as at least one intermediate layer-coating material.

Furthermore, in the coating method of the present invention, it is preferable that the uncured laminated coating film be subjected to a heat treatment below a temperature lower than a curing temperature of the uppermost layer-coating material by 20° C., and subsequently subjected to a heat treatment at or above the temperature lower than the curing temperature of the uppermost layer-coating material by 20° C.

The coated article of the present invention comprises a laminated coating film including a lowermost layer formed on a base material, at least one intermediate layer formed on the lowermost layer, and an uppermost layer formed on the intermediate layer, wherein the coated article is obtained by the above coating method. The coated article comprises the laminated coating film excellent in appearance qualities such as surface texture and gloss.

Here, it is not known exactly why the surface unevenness of a laminated coating film is reduced by the coating method of the present invention, even when three or more kinds of coating materials are applied in a wet-on-wet manner and baked. However, the present inventors speculate as follows. Specifically, in a laminated coating film formed in a conventional wet-on-wet manner, thermosetting coating materials are used for all layers including an uppermost layer, and the laminated coating film is designed so that the layers are simultaneously cured at the same heating temperature, or curing is started sequentially from a lower layer. Accordingly, when the thermosetting coating material for forming the uppermost layer is cured by a heat treatment (baking treatment), curing of the thermosetting coating materials proceeds also in the lower layers of the uppermost layer, and the lower layers lose the fluidity. In each layer of the laminated coating film, the thermosetting coating material is cured by a condensation reaction or by an addition reaction after the deblocking reaction of a curing agent. Accordingly, volatile products formed in this condensation reaction or deblocking reaction evaporate along with the residual solvents. This causes the shrinkage of the laminated coating film, and thereby unevenness is formed on the surface of the coating film. This surface unevenness of the coating film is reduced by the flowing or the like of the layers that keep having sufficient fluidity. However, when the fluidity of the uppermost layer significantly decreases because of the curing, the lower layers are also cured, and substantially lose the fluidity. As a result, the unevenness is not reduced, and unevenness on the surface of the base material or interfaces between layers is transferred to the surface of the uppermost layer. The present inventors speculate that the surface texture and gloss of the laminated coating film are deteriorated by the above phenomenon.

In contrast, in the coating method of the present invention, at least one layer (intermediate layer) other than the uppermost layer and than the lowermost layer is formed by using a thermosetting coating material containing a base resin having a low Tg. Accordingly, in curing the uppermost layer, the intermediate layer formed by using the thermosetting coating material containing a base resin having a low Tg remains in an uncured state, and a high fluidity thereof is retained. Furthermore, even in a subsequent cured state, high relaxivity (high molecular mobility, namely fluidity) can be achieved. Accordingly, even when unevenness is formed on the surface of the coating film by the shrinkage of the laminated coating film, this fluidity of the intermediate layer reduces the formation of the unevenness. The present inventors speculate that appearance of the unevenness on the surface of the coating film can be restrained by the above phenomenon.

### Advantageous Effect of Invention

According to the present invention, even when three or more kinds of coating materials are applied in a wet-on-wet manner and are baked to cure all the layers for ensuring a high durability or the like, a laminated coating film having an uppermost layer with less surface unevenness can be obtained. This makes it possible to obtain a coated article excellent in appearance qualities such as surface texture (surface smoothness) and gloss.

### DESCRIPTION OF EMBODIMENTS

Hereinafter, the present invention will be described in details on the basis of preferred embodiments thereof.

A coating method of the present invention is a coating method for forming a laminated coating film including a lowermost layer formed on a base material, at least one intermediate layer formed on the lowermost layer, and an uppermost layer formed on the intermediate layer, and the coating method comprises the steps of:

preparing a thermosetting coating material as a lowermost layer-coating material for forming the lowermost layer, preparing a thermosetting coating material as an intermediate layer-coating material for forming the intermediate layer,

wherein at least one thermosetting coating material for the intermediate layer is a thermosetting coating material containing a base resin having a glass transition temperature of 5° C. or less, and preparing a thermosetting coating material as an uppermost layer-coating material for forming the uppermost layer,

forming an uncured laminated coating film by applying the lowermost layer-, the intermediate layer- and the uppermost layer-coating materials on the base material in a wet-on-wet manner, and

curing the lowermost layer-, the intermediate layer- and the uppermost layer-coating materials by subjecting the uncured laminated coating film to a heat treatment.

In the coating method of the present invention, first, the lowermost layer-coating material is applied to the base material, and then a solvent and the like are evaporated by drying or the like when needed. Thus, an uncured lowermost layer is formed. Next, one or more kinds of intermediate layer-coating materials are applied to the uncured lowermost layer, and then a solvent and the like are evaporated by drying or the like when needed. Thus, an uncured intermediate layer is formed. At this time, a thermosetting coating material containing a base resin having a glass transition temperature of 5° C. or less (hereinafter referred to as a “low Tg thermosetting coating material”) is used as at least one thermosetting coating material used as the intermediate layer-coating material. Further, the uppermost layer-coating material is applied to the uncured intermediate layer, and then a solvent and the like are evaporated by drying or the like when needed. Thus, an uncured uppermost layer is formed. Thereafter, the uncured laminated coating film thus obtained is subjected to a heat treatment (baking treatment), and each of the layers is cured.

The base material used in the present invention is not particularly limited. Examples of the base material include metals (such as iron, copper, aluminum, tin, and zinc, as well as alloys of these metals), steel plates, plastics, foamed materials, paper, wood, cloth, and glass. Of those, the present invention is preferably adopted for steel plates for automobile, for which a high appearance quality is required. Surfaces of these base materials may be subjected to a treatment such as electrodeposition-coating in advance.

In the present invention, a thermosetting coating material is used as the lowermost layer-coating material. This surely improves the durability of the laminated coating film and the adhesion thereof to the base material. As such a thermosetting coating material for the lowermost layer, a thermosetting coating material used for ordinary baking finish can be used, and examples thereof include intermediate coating materials described in Japanese Unexamined Patent Application Publication No. 2004-275966. The form of the thermosetting coating material for the lowermost layer may be any of solvent-based form and water-based form, and the water-based form is preferable in view of capability of reducing in emission amount of volatile organic compounds. Moreover, the smaller the weight loss percentage of the thermosetting coating material for the lowermost layer at the curing temperature of the employed uppermost layer-coating material is, the more preferable the thermosetting coating material for the lowermost layer becomes, from the viewpoint of capability of minimizing the shrinkage of the coating film after the uppermost layer is cured by the heat treatment and thus the fluidity thereof significantly decreases.

Specific examples of the thermosetting coating material for the lowermost layer include thermosetting coating materials containing a thermosetting resin such as an acrylic resin, a polyester resin, an alkyd resin, an epoxy resin, or a urethane resin; and a curing agent such as an amino compound, an amino resin, an isocyanate compound, or an isocyanate resin. However, the thermosetting coating material for the lowermost layer is not limited thereto. The above-described thermosetting resins may be used alone or in combination of two or more kinds, and the above-described curing agents also may be used alone or in combination of two or more kinds.

The thermosetting coating material for the lowermost layer may contain any of conventionally known coloring pigments, luster pigments, and the like within a conventionally known scope when needed. Meanwhile, in order to adjust various properties, various additives such as a viscosity controlling agent, a surface conditioner, a thickening agent, an antioxidant, an ultraviolet absorber, and a defoamer, may be blended within a conventionally known scope.

In the coating method of the present invention, at least one intermediate layer is formed on the lowermost layer by using a thermosetting coating material. At least one intermediate layer is formed by using a low Tg thermosetting coating material containing a base resin having a glass transition temperature of 5° C. or less as an intermediate layer-coating material. Specifically, in the case of one intermediate layer, this intermediate layer is formed by using the low Tg thermosetting coating material. When two or more intermediate layers are provided, at least one intermediate layer is formed by using the low Tg thermosetting coating material, and the other layer (s) may be formed by using a high Tg thermosetting coating material containing a base resin having a glass transition temperature (Tg) exceeding 5° C. In this way, at least one intermediate layer is formed by using the low Tg thermosetting coating material. As a result, even when the uppermost layer is cured and the fluidity thereof significantly decreases, the fluidity of the intermediate layer is sufficiently retained, surface unevenness due to shrinkage of the laminated coating film is reduced, and thereby a laminated coating film excellent in appearance quality can be obtained.

Note that, in the present invention, the “base resin” means the main component of the resin included in the coating material. The glass transition temperature (Tg (unit: K)) of such a base resin can be calculated by the following Fox equation:

1/Tg=w₁/Tg₁+ . . . +wᵢ/Tgᵢ+ . . . +wₙ/Tgₙ

(wherein, wᵢ represents the mass fraction of a monomer i (i is an integer of 1 to n), and Tgᵢ represents the glass transition temperature (unit: K) of a homopolymer of the monomer i (i is an integer of 1 ton)) [refer to Bullet in of the American Physical Society, 13, p. 123 (1956)]. Note that, as the Tg of the homopolymer, the value described in J. Jpn. Soc. Colour Mater., 64, pp. 594-595 (1991) can be employed. As the Tg of the homopolymer not described in this reference, the value described in “POLYMER HANDBOOK (FOURTH EDITION)”, edited by J. BRANDRUP, E. H. IMMERGUT and E. A. GRULKE, JOHN WILEY & SONS, INC. can be employed. Also note that a base resin having a predetermined Tg can be prepared by adjusting the monomer composition.

In the coating method of the present invention, when two or more intermediate layers are provided, it is preferable that an intermediate layer close to the uppermost layer be formed by using the low Tg thermosetting coating material. As a result, the surface unevenness of the laminated coating film can be further reduced, and the appearance quality of the laminated coating film can be further improved.

Furthermore, in the coating method of the present invention, at least one above-described intermediate layer-coating material preferably has a weight loss percentage of 0.5% by mass or less, more preferably 0.3% by mass or less, and particularly preferably 0.1% by mass or less, at the curing temperature of the uppermost layer-coating material to be used. The use of at least one intermediate layer-coating material having such a low weight loss percentage leads to the tendency to minimize the shrinkage of the coating film after the uppermost layer is cured by the heat treatment and thus the fluidity thereof significantly decreases. In addition, from such viewpoints, an intermediate layer-coating material from which no volatile product is formed in curing the uppermost layer (i.e., having a weight loss percentage of 0% by mass) is most preferable.

Note that, in the present invention, the term “curing temperature of a coating material” refers to a temperature at which the curing of the coating material can be performed most efficiently in relation to other curing conditions such as curing time, in the case where a target coating material is applied to the base material, heat treatment is performed, and the coating film is cured to be fixed on the base material. In general, this term refers to a baking temperature which is set (designed) for each coating material. In the present invention, a value listed in its catalog can be employed as this curing temperature (baking temperature). Meanwhile, the term “weight loss percentage of a coating material” refers to a value determined by the following method. Specifically, a target coating material is applied to aluminum foil in such a manner that the film thickness of the coating material after heat treatment will be a target film thickness in the laminated coating film. The obtained aluminum foil sample is dried at a temperature, which is lower than the curing temperature T_{T} of the uppermost layer-coating material by 40° C. (T_{T}-40° C.), under the vacuum condition of 10⁻² Torr or less for 90 minutes. Thereafter, the sample is heated at the curing temperature of the uppermost layer-coating material for 30 minutes by using a gas chromatograph/mass spectrometer (for example, 6890GC/5975MSD manufactured by Agilent Technologies, Inc.) equipped with a thermal desorption introduction system (for example, Thermal Desorption System manufactured by GERSTEL K.K.) to quantitatively determine the amount of volatile products (Rc (unit: g)) and the amount of the residual solvents in the sample. Then, the weight loss percentage is calculated by Formula (1). The weight loss percentage is a percentage of the amount of the volatile products relative to the total amount of binders in the coating film.

Weight loss percentage=100×Rc/W×100/(100−P) (1)

In Formula (1), W is the mass (unit: g) of the coating film obtained in the vacuum drying step, and P is the mass (unit: g) of pigments contained in 100 g of the coating film. Note that the value in the composition table (the value described in its catalog or the like) of the coating material can be employed as the mass of the pigments.

The low Tg thermosetting coating material used in the present invention contains a base resin having a Tg of 5° C. or less. The low Tg thermosetting coating material preferably contains a base resin having a Tg of −5° C. or lower, and more preferably a base resin having a Tg of −15° C. or lower. If the Tg of the base resin exceeds the upper limit, there is a tendency that the intermediate layer is also cured along with the uppermost layer, and thereby the fluidity is not sufficiently retained when the fluidity of the uppermost layer significantly decreases because of the curing thereof. Accordingly, there is a tendency that the surface unevenness of the coating film is not reduced and thereby the surface texture and gloss of the laminated coating film are deteriorated.

Examples of the base resin used in such a low Tg thermosetting coating material include acrylic resins, polyester resins, alkyd resins, epoxy resins, and urethane resins; however, the base resin is not limited thereto. These resins may be used alone or in combination of two or more kinds. The Tg of such a base resin can be calculated by the aforementioned Fox equation, and a base resin having a predetermined Tg can be obtained by adjusting the monomer composition.

Examples of the curing agent contained in the low Tg thermosetting coating material include isocyanate compounds, isocyanate resins, amine compounds, and amino resins. These curing agents may be used alone or in combination of two or more kinds.

Of those low Tg thermosetting coating materials, a low Tg thermosetting coating material from which substantially no volatile product is formed in curing the uppermost layer is preferably used in view of reducing the shrinkage of the coating film after the uppermost layer is cured by the heat treatment and thus the fluidity thereof significantly decreases. Such a coating material preferably has a weight loss percentage of 0.5% by mass or less, more preferably 0.3% by mass or less, and particularly preferably 0.1% by mass or less, at the curing temperature of the uppermost layer-coating material to be used. The use of such a low Tg thermosetting coating material having a low weight loss percentage as the intermediate layer-coating material leads to the tendency to minimize the shrinkage of the coating film after the uppermost layer is cured by the heat treatment and thus the fluidity thereof significantly decreases. In addition, from such viewpoints, a low Tg thermosetting coating material from which no volatile product is formed in curing the uppermost layer (i.e., having a weight loss percentage of 0% by mass) is most preferable.

In the present invention, the form of the low Tg thermosetting coating material may be any of solvent-based form, water-based form and powder forms, and the water-based form or the powder form is preferable in view of capability of reducing in emission amount of volatile organic compounds. In addition, the low Tg thermosetting coating material may contain conventionally known coloring pigments, luster pigments, and the like within a conventionally known scope when needed. Furthermore, in order to adjust various properties, various additives such as a viscosity controlling agent, a surface conditioner, a thickening agent, an antioxidant, an ultraviolet absorber, and a defoamer, may be blended within a conventionally known scope.

In the present invention, when two or more intermediate layers are provided, as long as at least one intermediate layer is formed by using the low Tg thermosetting coating material, the other layer (s) may be formed by using a high Tg thermosetting coating material containing a base resin having a Tg exceeding 5° C.

As such a high Tg thermosetting coating material for the intermediate layer, a thermosetting coating material used for ordinary baking finish can be used as long as the thermosetting coating material contains a base resin having a Tg exceeding 5° C., and examples thereof include base coating materials which are described in Japanese Unexamined Patent Application Publication No. 2004-275966, and which contain a base resin having a Tg exceeding 5° C. The Tg of such a base resin can be calculated by the aforementioned Fox equation, and a base resin having a predetermined Tg can be obtained by adjusting the monomer composition. The form of the high Tg thermosetting coating material for the intermediate layer may be any of solvent-based form and water-based form, and the water-based form is preferable in view of capability of reducing in emission amount of volatile organic compounds.

In addition, in view of capability of reducing the shrinkage of the coating film after the uppermost layer is cured by the heat treatment and thus the fluidity thereof significantly decreases, a high Tg thermosetting coating material from which substantially no volatile product is formed in curing the uppermost layer is preferably used as the intermediate layer-coating material. Such a coating material preferably has a weight loss percentage of 0.5% by mass or less, more preferably 0.3% by mass or less, and particularly preferably 0.1% by mass or less, at the curing temperature of the uppermost layer-coating material to be used. The use of such a high Tg thermosetting coating material having a low weight loss percentage as the intermediate layer-coating material leads to the tendency to minimize the shrinkage of the coating film after the uppermost layer is cured by the heat treatment and thus the fluidity thereof significantly decreases. In addition, from such viewpoints, a high Tg thermosetting coating material from which no volatile product is formed in curing the uppermost layer (i.e., having a weight loss percentage of 0% by mass) is most preferable.

Specific examples of the high Tg thermosetting coating material for the intermediate layer include thermosetting coating materials containing a thermosetting resin (base resin) such as an acrylic resin, a polyester resin, an alkyd resin, an epoxy resin, or a urethane resin; and a curing agent such as an amine compound, an amino resin, an isocyanate compound, or an isocyanate resin. However, the high Tg thermosetting coating material for the intermediate layer is not limited thereto. The above-described thermosetting resins may be used alone or in combination of two or more kinds, and the above-described curing agents also may be used alone or in combination of two or more kinds.

The high Tg thermosetting coating material for the intermediate layer may contain conventionally known coloring pigments, luster pigments, and the like within a conventionally known scope when needed. Meanwhile, in order to adjust various properties, various additives such as a viscosity controlling agent, a surface conditioner, a thickening agent, an antioxidant, an ultraviolet absorber, and a defoamer, may be blended within a conventionally known scope.

In the present invention, a thermosetting coating material is used as the uppermost layer-coating material. As the thermosetting coating material for the uppermost layer, any thermosetting coating material can be used, as long as the thermosetting coating material contains a thermosetting resin (base resin) capable of being formed into a coating film, and a curing agent (for example, a compound or a resin having two or more functional groups capable of reacting with functional groups of the thermosetting resin). Examples of the thermosetting coating material include thermosetting coating materials used as an uppermost layer-coating material for ordinary baking finish (for example, clear coating materials described in Japanese Unexamined Patent Application Publication No. 2004-275966). The form of the thermosetting coating material may be any of solvent-based form, water-based form and powder form. The curing temperature of the thermosetting coating material for the uppermost layer is not particularly limited; however, the curing temperature is normally 40 to 200° C., and preferably 60 to 160° C.

Of these thermosetting coating materials for the uppermost layer, a high Tg thermosetting coating material containing a base resin having a Tg exceeding 5° C. is preferable. If a thermosetting coating material containing a base resin having a Tg at the lower limit or below is used as the uppermost layer-coating material, the mechanical properties and the durability of the laminated coating film tend to be deteriorated. The Tg of the base resin used in the uppermost layer-coating material can be calculated by the aforementioned Fox equation, and a base resin having a predetermined Tg can be obtained by adjusting the monomer composition.

Examples of the base resin contained in the uppermost layer-coating material include acrylic resins, polyester resins, alkyd resins, epoxy resins, and urethane resins; however, the base resin is not limited thereto. Examples of preferable curing agents include amino compounds, amino resins, isocyanate compounds, and isocyanate resins; however, the curing agent is not limited thereto. These resins may be used alone or in combination of two or more kinds, and these curing agents also may be used alone or in combination of two or more kinds.

In the coating method of the present invention, the uppermost layer-coating material is preferably a coating material from which substantially no volatile product is formed in the curing reaction by the heat treatment. Such a coating material preferably has a weight loss percentage of 0.5% by mass or less, more preferably 0.3% by mass or less, and particularly preferably 0.1% by mass or less, at the curing temperature thereof. The use of such a thermosetting coating material having a low weight loss percentage as the uppermost layer-coating material leads to the tendency to minimize the shrinkage of the coating film due to the heat treatment. In addition, from such viewpoints, a coating material from which no volatile product is formed (i.e., having a weight loss percentage of 0% by mass) is most preferable.

Examples of a combination of the thermosetting resin with the curing agent from which no volatile product is formed in the curing reaction by the heat treatment include a combination of a hydroxy group-containing acrylic resin with an isocyanate compound and/or an isocyanate resin, and a combination of an epoxy group-containing acrylic resin with a polyvalent carboxylic acid compound and/or a carboxyl group-containing resin.

Furthermore, the uppermost layer-coating material may contain conventionally known coloring pigments, luster pigments, and the like within a conventionally known scope when needed. Meanwhile, in order to adjust various properties, various additives such as a viscosity controlling agent, a surface conditioner, a thickening agent, an antioxidant, an ultraviolet absorber, and a defoamer, may be blended within a conventionally known scope.

In the coating method of the present invention, first the lowermost layer-coating material is applied to the base material, and then a solvent is evaporated by drying or the like when needed. Thus, an uncured lowermost layer is formed. Examples of the method for applying the lowermost layer-coating material include conventionally known methods such as air spray coating, air electrostatic spray coating, and rotary atomizing electrostatic coating.

The film thickness of the lowermost layer can be appropriately set in accordance with a desired application. For example, the film thickness after the heat treatment is preferably 5 to 50 μm, and more preferably 10 to 40 μm. If the film thickness of the lowermost layer is less than the lower limit, it tends to be difficult to obtain a uniform coating film for the lowermost layer. On the other hand, if the film thickness exceeds the upper limit, there are tendencies that the lowermost layer absorbs a large amount of solvent and the like contained in a coating film for the uppermost layer, and that the evaporation of the solvent contained in the lowermost layer itself is prevented and thereby the appearance quality of the laminated coating film is deteriorated.

Next, the intermediate layer-coating material is applied to the uncured lowermost layer, and a solvent is evaporated by drying or the like when needed. Thus, an uncured intermediate layer is formed. At this time, when only one intermediate layer is provided, this intermediate layer is formed by using the low Tg thermosetting coating material. When two or more intermediate layers are provided, at least one layers is formed by using the low Tg thermosetting coating material, and the other layer(s) may be formed by using the high Tg thermosetting coating material for the intermediate layer. When two or more intermediate layers are provided, the intermediate layer close to the uppermost layer is preferably formed by using the low Tg thermosetting coating material in view of the capability of further reducing the surface unevenness of the laminated coating film.

In the case of using each of the low Tg thermosetting coating material and the high Tg thermosetting coating material when the intermediate layer-coating material is applied, conventionally known methods such as air spray coating, air electrostatic spray coating, and rotary atomizing electrostatic coating can be employed.

The film thickness of each intermediate layer can be appropriately set in accordance with a desired application.

For example, the film thickness after the heat treatment is preferably 5 to 50 μm, and more preferably 10 to 40 μm. If the film thickness of any intermediate layer is less than the lower limit, it tends to be difficult to obtain a uniform coating film for the intermediate layer. On the other hand, if the film thickness exceeds the upper limit, there are tendencies that the intermediate layer absorbs a large amount of solvent and the like contained in the coating film for the uppermost layer, and that the evaporation of the solvent contained in the intermediate layer itself is prevented and thereby the appearance quality of the laminated coating film is deteriorated.

Next, the uppermost layer-coating material is applied to the uncured intermediate layer, and a solvent is evaporated by drying or the like when needed. Thus, an uncured uppermost layer is formed. Examples of a coating method of the uppermost layer-coating material include conventionally known methods such as air spray coating, air electrostatic spray coating, rotary atomizing electrostatic coating.

The film thickness of the uppermost layer can be appropriately set in accordance with a desired application. For example, the film thickness after the heat treatment is preferably 15 to 60 μm, and more preferably 20 to 50 μm. If the film thickness of the uppermost layer is less than the lower limit, the fluidity is insufficient and thereby the appearance quality of the laminated coating film tends to be deteriorated. On the other hand, if the film thickness exceeds the upper limit, the fluidity is excessively high, and thereby defect such as dripping tends to occur in a case where the coating is performed in a vertical direction.

As described above, the lowermost layer-, the intermediate layer- and the uppermost layer-coating materials are applied in a wet-on-wet manner, and the uncured laminated coating film thus formed are subjected to a heat treatment (baking treatment) to cure each of the layers. In the coating method of the present invention, the heat treatment preferably includes a heat treatment performed at or above a temperature at which at least the uppermost layer is cured, for example, at or above a temperature lower than the curing temperature of the uppermost layer-coating material by 20° C. (hereinafter, referred to as a “high-temperature heat treatment”).

The temperature for the high temperature heating is further preferably within the temperature range of ±20° C. from the curing temperature of the uppermost layer-coating material. Specifically, when the curing temperature of the uppermost layer-coating material is 140° C., the temperature for the high temperature heating is preferably 120° C. or higher, and more preferably from 120° C. to 160° C. both inclusive. The duration for the high temperature heating is preferably 50% to 150% both inclusive, and more preferably 60% to 100% both inclusive, of the curing time of the uppermost layer-coating material. Specifically, when the curing time of the uppermost layer-coating material is 30 minutes, the duration for the high temperature heating is preferably 15 minutes to 45 minutes both inclusive, and more preferably 18 minutes to 30 minutes both inclusive.

Furthermore, in the coating method of the present invention, it is preferable to reduce, without curing the uppermost layer, the concentration of volatile components in the laminated coating film before the high-temperature heat treatment is performed. This leads to the tendency to minimize the shrinkage of the laminated coating film after the uppermost layer is cured by the high-temperature heat treatment and thus the fluidity thereof significantly decreases.

As a method for reducing the concentration of volatile components in the laminated coating film without curing the uppermost layer, preferred is a method in which a heat treatment (hereinafter referred to as a “low-temperature heat treatment”) is performed below a temperature lower than the curing temperature of the uppermost layer-coating material by 20° C. The temperature for the low temperature heating is further preferably below a temperature lower than the curing temperature of the uppermost layer-coating material by 30° C., and particularly preferably below a temperature lower than the curing temperature of the uppermost layer-coating material by 40° C. Specifically, when the curing temperature of the uppermost layer-coating material is 140° C., the temperature for the low temperature heating is preferably below 120° C., more preferably below 110° C., and particularly preferably below 100° C. The duration for the low temperature heating is preferably 10% inclusive to 50% exclusive, and preferably 20% to 40% both inclusive, of the curing time of the uppermost layer-coating material. Specifically, when the curing time of the uppermost layer-coating material is 30 minutes, the duration for the low temperature heating is preferably 3 minutes to 15 minutes both inclusive, and preferably 6 minutes to 12 minutes both inclusive. When the uncured laminated coating film is subjected to a heat treatment in the ranges of the temperature for the low temperature heating and the duration for the low temperature heating, there is a tendency that the concentration of volatile components in the laminated coating film can be reduced without substantially curing the uppermost layer.

Furthermore, in the coating method of the present invention, in order to stabilize the uncured state of the coating film applied in the wet-on-wet manner, the uncured coating film is preferably allowed to stand (subjected to setting) at room temperature before the heat treatment. The setting duration is generally set to 1 to 20 minutes.

In addition, in order to obtain a coated article having a higher quality appearance in the present invention, a surface layer is preferably formed by further applying one or more kinds of coating materials to the uppermost layer of a coated article obtained by the above-described coating method, and then performing a curing treatment thereon. As the coating materials, those listed as the examples of the uppermost layer-coating material can be used. Examples of the coating method of the coating materials include conventionally known methods such as air spray coating, air electrostatic spray coating and rotary atomizing electrostatic coating.

The coated article of the present invention is produced according to the coating method of the present invention. The coated article comprises a laminated coating film having less surface unevenness than laminated coating films produced in a conventional wet-on-wet manner, and is excellent in appearance quality. Such coated articles are useful especially as bodies or components of automobiles such as passenger cars, trucks, buses and motorcycles.

### EXAMPLES

Hereinafter, the present invention will be described more specifically on the basis of Examples and Comparative Examples. However, the present invention is not limited to the following Examples. Note that the glass transition temperature (Tg) of each base resin and the weight loss percentage of each coating material by a heat treatment are determined by the following methods.

<Calculation of Glass Transition Temperature>

Calculation was made by using the following Fox equation:

1/Tg=w₁/Tg₁+ . . . +wᵢ/Tgᵢ+ . . . +wₙ/Tgₙ

(wherein, wᵢ represents the mass fraction of a monomer i (i is an integer of 1 to n), and Tgᵢ represents the glass transition temperature (unit: K) of a homopolymer of the monomer i (i is an integer of 1 to n)).
Note that Tgs of homopolymers of monomers used in Examples and Comparative Examples are shown below:

| | |
|---|---|
| Methyl methacrylate | 105° C. |
| Butyl acrylate | −54° C. |
| 2-Hydroxyethyl acrylate | −15° C. |
| 2-Hydroxyethyl methacrylate | 55° C. |
| Styrene | 100° C. |
| Acrylic acid | 106° C. |

<Determination of Weight Loss Percentage>

A target coating material was applied to aluminum foil in a way that the film thickness of the coating material after a heat treatment would be a target film thickness in a laminated coating film. The obtained aluminum foil sample was dried at a temperature, which is lower than the curing temperature of the uppermost layer-coating material by 40° C., under the vacuum condition of 10⁻² Torr or less for 90 minutes. Thereafter, the sample was heated at the curing temperature of the uppermost layer-coating material for 30 minutes by using a gas chromatograph/mass spectrometer (for example, 6890GC/5975MSD manufactured by Agilent Technologies, Inc.) equipped with a thermal desorption introduction system (for example, Thermal Desorption System manufactured by GERSTEL K.K.) to quantitatively determine the amount of volatile products (Rc (unit: g)) and the amount of residual solvents in the sample. Then, the weight loss percentage was calculated by Formula (1). The weight loss percentage is a percentage of the amount of the volatile products relative to the total amount of the binders in the coating film.

Weight loss percentage=100×Rc/W×100/(100−P) (1)

In Formula (1), W is the mass (unit: g) of the coating film obtained in the vacuum drying step, and P is the mass (unit: g) of pigments contained in 100 g of the coating film. Note that the value in the composition table of the coating material was used as the mass of the pigments.

### Synthesis Example 1

### Synthesis of Acrylic Emulsion R-1

The following monomers were mixed to prepare a monomer mixture liquid.

<Monomer Mixture Composition>

| | |
|---|---|
| Methyl methacrylate | 69.3 parts by mass |
| Butyl acrylate | 94.5 parts by mass |
| 2-Hydroxyethyl acrylate | 63.0 parts by mass |
| Styrene | 78.8 parts by mass |
| Acrylic acid | 9.5 parts by mass |

315 parts by mass of this monomer mixture liquid, 4 parts by mass of n-dodecyl mercaptan, 105 parts by mass of water and 14 parts by mass of an anionic surfactant (“Newcol 707-SN” manufactured by NIPPON NYUKAZAI CO., LTD.) were mixed, and emulsified by stirring with a mixer. Thus, a monomer pre-emulsion was prepared.

Next, into an ordinary reaction vessel for producing an acrylic resin emulsion equipped with a stirrer, a thermometer, a dropping funnel, a reflux condenser and a nitrogen inlet tube, 280 parts by mass of water, 5.6 parts by mass of an anionic surfactant (“Newcol 707-SN” manufactured by NIPPON NYUKAZAI CO., LTD.), and, as an polymerization initiator, 20 parts by mass of an ammonium persulfate aqueous solution (prepared by stirring and mixing 0.7 parts by mass of ammonium persulfate (manufactured by Sigma-Aldrich Co.) and 13.3 parts by mass of water) were put, and heated to 80° C. with stirring. To this solution, 5% by mass of the total amount of the monomer pre-emulsion was added, and the mixture was held at 80° C. for 10 minutes. Thereafter, the remainder of the monomer pre-emulsion was added dropwise with stirring over a period of 4 hours. After the dropwise addition, stirring was continued at 80° C. for another hour, and reaction was allowed to proceed. Thereafter, 56 parts by mass of water was added thereto and the mixture was cooled to room temperature. After the cooling, by using 10% by mass of a dimethylethanolamine aqueous solution, the pH of the reaction solution was adjusted to 7.2. Thus, an acrylic emulsion R-1 having a non-volatile content of 38.1% by mass and a Tg of 15° C. was obtained.

### Synthesis Example 2

### Synthesis of Acrylic Emulsion R-2

The following monomers were mixed to prepare a monomer mixture liquid.

<Monomer Mixture Composition>

| | |
|---|---|
| Methyl methacrylate | 10.7 parts by mass |
| Butyl acrylate | 203.2 parts by mass |
| 2-Hydroxyethyl methacrylate | 50.4 parts by mass |
| Styrene | 42.5 parts by mass |
| Acrylic acid | 8.2 parts by mass |

An acrylic emulsion R-2 having a non-volatile content of 38.1% by mass and a Tg of −20° C. was obtained in the same manner as in Synthesis Example 1, except that 315 parts by mass of this monomer mixture liquid was used in place of the monomer mixture liquid described in Synthesis Example 1 and that the pH of the reaction solution was adjusted to 7.4.

### Synthesis Example 3

### Synthesis of Acrylic Emulsion R-3

The following monomers were mixed to prepare a monomer mixture liquid.

<Monomer Mixture Composition>

| | |
|---|---|
| Methyl methacrylate | 22.7 parts by mass |
| Butyl acrylate | 178.6 parts by mass |
| 2-Hydroxyethyl methacrylate | 50.4 parts by mass |
| Styrene | 55.1 parts by mass |
| Acrylic acid | 8.2 parts by mass |

An acrylic emulsion R-3 having a non-volatile content of 38.1% by mass and a Tg of −10° C. was obtained in the same manner as in Synthesis Example 2, except that 315 parts by mass of this monomer mixture liquid was used in place of the monomer mixture liquid described in Synthesis Example 2.

### Synthesis Example 4

### Synthesis of Acrylic Emulsion R-4

The following monomers were mixed to prepare a monomer mixture liquid.

<Monomer Mixture Composition>

| | |
|---|---|
| Methyl methacrylate | 36.2 parts by mass |
| Butyl acrylate | 155.6 parts by mass |
| 2-Hydroxyethyl methacrylate | 50.4 parts by mass |
| Styrene | 64.6 parts by mass |
| Acrylic acid | 8.2 parts by mass |

An acrylic emulsion R-4 having a non-volatile content of 38.1% by mass and a Tg of 0° C. was obtained in the same manner as in Synthesis Example 2, except that 315 parts by mass of this monomer mixture liquid was used in place of the monomer mixture liquid described in Synthesis Example 2.

### Synthesis Example 5

### Synthesis of Acrylic Emulsion R-5

The following monomers were mixed to prepare a monomer mixture liquid.

<Monomer Mixture Composition>

| | |
|---|---|
| Methyl methacrylate | 48.8 parts by mass |
| Butyl acrylate | 133.6 parts by mass |
| 2-Hydroxyethyl methacrylate | 50.4 parts by mass |
| Styrene | 74.0 parts by mass |
| Acrylic acid | 8.2 parts by mass |

An acrylic emulsion R-5 having a non-volatile content of 38.1% by mass and a Tg of 10° C. was obtained in the same manner as in Synthesis Example 2, except that 315 parts by mass of this monomer mixture liquid was used in place of the monomer mixture liquid described in Synthesis Example 2.

### Synthesis Example 6

### Synthesis of Acrylic Emulsion R-6

The following monomers were mixed to prepare, and thereby a monomer mixture liquid.

<Monomer Mixture Composition>

| | |
|---|---|
| Methyl methacrylate | 78.8 parts by mass |
| Butyl acrylate | 77.5 parts by mass |
| 2-Hydroxyethyl methacrylate | 50.4 parts by mass |
| Styrene | 100.2 parts by mass |
| Acrylic acid | 8.2 parts by mass |

An acrylic emulsion R-6 having a non-volatile content of 38.1% by mass and a Tg of 40° C. was obtained in the same manner as in Synthesis Example 2, except that 315 parts by mass of this monomer mixture liquid was used in place of the monomer mixture liquid described in Synthesis Example 2.

### Preparation Example 1

### Preparation of Coloring Pigment Paste

Into a stainless steel container, 123 parts by mass of water, 30 parts by mass of a urethane dispersion (“HYDRAN WLS-202” manufactured by DIC Corporation), 1.5 parts by mass of a wetting and dispersing additive (“Disperbyk181” manufactured by BYK Japan KK), 1.5 parts by mass of a defoamer (“SN defoamer 1340” manufactured by SAN NOPCO LIMITED), and 323.4 parts by mass of rutile-type titanium oxide (“CR-90-2” manufactured by ISHIHARA SANGYO KAISHA, LTD.) were put, and premixed for three minutes. Then, glass beads (with a particle diameter of 1.6 mm) were added in a volumetric amount equivalent to the total volumetric amount of put materials, and dispersing treatment was performed for one hour by using a bench-top sand mill. The particle size as determined by using a grind gauge after the completion of the dispersing was 5 μm or smaller.

### Preparation Example 2

### Preparation of Melamine-Curable and Water-Based Intermediate Coating Material P-1

Into a container, 244.9 parts by mass of the coloring pigment paste obtained in Preparation Example 1 was put, and with stirring 170.6 parts by mass of the acrylic emulsion R-1 obtained in Synthesis Example 1 and 40.3 parts by mass of a methylated melamine resin (“Cymel 325” manufactured by Nihon Cytec Industries Inc.) were added thereto. Then, a stirring was performed for 5 minutes. Thereafter, 20 parts by mass of water, 8 parts by mass of butyl diglycol and 16 parts by mass of butyl glycol were added thereto and a stirring was performed for 5 minutes. Further, appropriate amounts of an alkali thickening agent (“Viscalex HV30” manufactured by Ciba Specialty Chemicals), dimethylethanolamine and water were added thereto. Thus, a melamine-curable and water-based intermediate coating material P-1 having a non-volatile content of 48.3% by mass and a pH of 8.4 was obtained. The curing temperature of this water-based intermediate coating material P-1 was 140° C. The mass of all pigment components (%) (hereinafter referred to as “PWC”) relative to the total solid content mass in the blend of this water-based intermediate coating material P-1 was 42.

### Preparation Example 3

### Preparation of Melamine-Curable and Water-Based Base Coating Material B-1

Into a container, 183.7 parts by mass of the acrylic emulsion R-2 obtained in Synthesis Example 2 and having a Tg of −20° C. was put, and with stirring 40 parts by mass of a methylated melamine resin (“Cymel 325” manufactured by Nihon Cytec Industries Inc.) and 150 parts by mass of water and 20 parts by mass of butyl glycol were added thereto. Then, a stirring was performed for 5 minutes. Further, appropriate amounts of an alkali thickening agent (“Viscalex HV30” manufactured by Ciba Specialty Chemicals), dimethylethanolamine and water were added thereto. Thus, a water-based resin solution having a non-volatile content of 23% by mass and a pH of 8.5 was obtained.

Meanwhile, into another container, 53 parts by mass of butyl glycol and 5 parts by mass of a phosphoric ester compound (“Lubrizol 2062” manufactured by Lubrizol Japan Ltd.) were put, and a stirring was performed for 5 minutes. To this solution, two kinds of aluminum pastes (“Hydrolan 2154” manufactured by ECKART GmbH and “Hydrolan 2156” manufactured by ECKART GmbH) were added by 30 parts by mass of each. Then, a stirring was performed for 1 hour, and thereby an aluminum paste solution was obtained.

Next, to 457.7 parts by mass of the aforementioned water-based resin solution, 101.6 parts by mass of this aluminum paste solution was added with stirring, and a stirring was performed for another hour. Thereby, a melamine-curable and water-based base coating material B-1 having a non-volatile content of 24.7% by mass and a pH of 8.0 was obtained. The weight loss percentage of this water-based base coating material B-1 at 140° C. was 3.6% by mass (the calculation was made assuming that P=22.4).

### Preparation Example 4

### Preparation of Melamine-Curable and Water-Based Base Coating Material B-2

A melamine-curable and water-based base coating material

B-2 having a non-volatile content of 24.7% by mass and a pH of 8.0 was obtained in the same manner as in Preparation Example 3, except that 183.7 parts by mass of the acrylic emulsion R-3 obtained in Synthesis Example 3 and having a Tg of −10° C. was used in place of the acrylic emulsion R-2. The weight loss percentage of this water-based base coating material B-2 at 140° C. was 3.7% by mass (the calculation was made assuming that P=22.4).

### Preparation Example 5

### Preparation of Melamine-Curable and Water-Based Base Coating Material B-3

A melamine-curable and water-based base coating material B-3 having a non-volatile content of 24.7% by mass and a pH of 8.0 was obtained in the same manner as in Preparation Example 3, except that 183.7 parts by mass of the acrylic emulsion R-4 obtained in Synthesis Example 4 and having a Tg of 0° C. was used in place of the acrylic emulsion R-2. The weight loss percentage of this water-based base coating material B-3 at 140° C. was 3.6% by mass (the calculation was made assuming that P=22.4).

### Preparation Example 6

### Preparation of Melamine-Curable and Water-Based Base Coating material B-4

A melamine-curable and water-based base coating material B-4 having a non-volatile content of 24.7% by mass and a pH of 8.0 was obtained in the same manner as in Preparation Example 3, except that 183.7 parts by mass of the acrylic emulsion R-5 obtained in Synthesis Example 5 and having a Tg of 10° C. was used in place of the acrylic emulsion R-2. The weight loss percentage of this water-based base coating material B-4 at 140° C. was 3.8% by mass (the calculation was made assuming that P=22.4).

### Preparation Example 7

### Preparation of Melamine-Curable and Water-Based Base Coating Material B-5

A melamine-curable and water-based base coating material B-5 having a non-volatile content of 24.7% by mass and a pH of 8.0 was obtained in the same manner as in Preparation Example 3, except that 183.7 parts by mass of the acrylic emulsion R-6 obtained in Synthesis Example 6 and having a Tg of 40° C. was used in place of the acrylic emulsion R-2. The weight loss percentage of this water-based base coating material B-5 at 140° C. was 3.6% by mass (the calculation was made assuming that P=22.4).

### Preparation Example 8

### Preparation of Isocyanate-Curable and Water-Based Base Coating Material B-6

An isocyanate-curable and water-based base coating material B-6 having a non-volatile content of 24.7% by mass and a pH of 8.0 was obtained in the same manner as in Preparation Example 3, except that the amount of the acrylic emulsion R-2 having a Tg of −20° C. was changed to 210 parts by mass, and that 25 parts by mass of a water dispersible polyisocyanate (“BURNOCK DNW5000” manufactured by DIC Corporation) was used in place of the methylated melamine resin. The weight loss percentage of this water-based base coating material B-6 at 140° C. was 0% by mass (the calculation was made assuming that P=22.4).

### Preparation Example 9

### Preparation of Isocyanate-Curable and Water-Based Base Coating Material B-7

An isocyanate-curable and water-based base coating material B-7 having a non-volatile content of 24.7% by mass and a pH of 8.0 was obtained in the same manner as in Preparation Example 3, except that 210 parts by mass of the acrylic emulsion R-3 obtained in Synthesis Example 3 and having a Tg of −10° C. was used in place of the acrylic emulsion R-2. The weight loss percentage of this water-based base coating material B-7 at 140° C. was 0% by mass (the calculation was made assuming that P=22.4).

### Preparation Example 10

### Preparation of Isocyanate-Curable and Water-Based Base Coating Material B-8

An isocyanate-curable and water-based base coating material B-8 having a non-volatile content of 24.7% by mass and a pH of 8.0 was obtained in the same manner as in Preparation Example 3, except that 210 parts by mass of the acrylic emulsion R-4 obtained in Synthesis Example 4 and having a Tg of 0° C. was used in place of the acrylic emulsion R-2. The weight loss percentage of this water-based base coating material B-8 at 140° C. was 0% by mass (the calculation was made assuming that P=22.4).

### Preparation Example 11

### Preparation of Isocyanate-Curable and Water-Based Base Coating Material B-9

An isocyanate-curable and water-based base coating material B-9 having a non-volatile content of 24.7% by mass and a pH of 8.0 was obtained in the same manner as in Preparation Example 3, except that 210 parts by mass of the acrylic emulsion R-5 obtained in Synthesis Example 5 and having a Tg of 10° C. was used in place of the acrylic emulsion R-2. The weight loss percentage of this water-based base coating material B-9 at 140° C. was 0% by mass (the calculation was made assuming that P=22.4).

### Preparation Example 12

### Preparation of Isocyanate-Curable and Water-Based Base Coating Material B-10

An isocyanate-curable and water-based base coating material B-10 having a non-volatile content of 24.7% by mass and a pH of 8.0 was obtained in the same manner as in Preparation Example 3, except that 210 parts by mass of the acrylic emulsion R-6 obtained in Synthesis Example 6 and having a Tg of 40° C. was used in place of the acrylic emulsion R-2. The weight loss percentage of this water-based base coating material B-10 at 140° C. was 0% by mass (the calculation was made assuming that P=22.4).

### Preparation Example 13

### Preparation of Thermosetting (Isocyanate-Curable) Clear Coating Material C

A polyol and additives were mixed together in proportions shown in Table 1. Thus, 80.51 parts by mass of a main agent for a two pack thermosetting (isocyanate-curable) clear coating material was prepared. Meanwhile, as a curing agent for the thermosetting clear coating material, an isocyanate curing agent shown in Table 1 was used. In each of the following Examples and Comparative Examples, a mixture obtained by mixing this main agent and this curing agent in proportions shown in Table 1 (solid content concentration: 55% by mass) was used as a thermosetting (isocyanate-curable) clear coating material C. The curing temperature of this thermosetting clear coating material C was 140° C., and the weight loss percentage thereof at 140° C. was 0% by mass.

TABLE 1

| | | | Blended |
|---|---|---|---|
| | | | amount |
| | | Product name | (% by mass) |
| Main | Polyol | Desmophen A 870 BA (70% in butyl | 51.15 |
| agent | | acetate; manufactured by Bayer AG) | |
| | Additive | Baysilone Paint Additive OL17 (10% in | 0.53 |
| | | xylene; manufactured by Borchers GmbH) | |
| | | Modaflow (1% in xylene; | 0.53 |
| | | manufactured by Monsanto Company) | |
| | | Tinuvin 292 (10% in xylene; | 5.33 |
| | | manufactured by Ciba Inc.) | |
| | | Tinuvin 1130 (10% in xylene; | 10.67 |
| | | manufactured by Ciba Inc.) | |
| | | 1-Methoxypropylacetate-2/solvent | 10.17 |
| | | naphtha 100 (1:1) | |
| | | Butyl glycol acetate | 2.13 |

| | | |
|---|---|---|
| Curing agent | Desmodur N 3390 Ba/SN | 19.49 |
| | (90% in butyl acetate/solvent naphtha | |
| | 100 (1:1); manufactured by Bayer AG) | |
| Total | | 100 |

### Example 1

The melamine-curable and water-based intermediate coating material P-1 (curing temperature: 140° C.) obtained in Preparation Example 2 was applied to a surface of an electrodeposition-coated plate (“Sacsade#80V gray” manufactured by DuPont Shinto Automotive Systems Co., Ltd.) in a way that the film thickness thereof after baking was to be 20 μm, and the plate was heated at 100° C. for 3 minutes to evaporate water, the organic solvents, and the like. Next, to this layer of the water-based intermediate coating material P-1, the melamine-curable and water-based base coating material B-1 (whose base resin had a Tg of −20° C.) obtained in Preparation Example 3 was applied in a way that the film thickness thereof after baking was to be 15 μm, and the plate was heated at 80° C. for 3 minutes to evaporate water, organic solvents, and the like. Next, the thermosetting clear coating material C obtained in Preparation Example 13 was applied to this layer of the water-based base coating material B-1 in a way that the film thickness thereof after baking was to be 35 μm. Thus, an uncured laminated coating film was obtained in which the melamine-curable and water-based intermediate coating material P-1, the melamine-curable and water-based base coating material B-1 and the thermosetting clear coating material C were applied in a wet-on-wet manner.

This uncured laminated coating film was allowed to stand (subjected to setting) at room temperature for 10 minutes, and then a heat treatment (baking treatment) at 90° C. for 10 minutes and a heat treatment (baking treatment) at 140° C. for 30 minutes were sequentially performed to thereby cure each layer. Thus, a laminated coating film was obtained.

The obtained laminated coating film was subjected to determination of wave scan values [Wa (wavelength: <0.3 mm), Wb (wavelength: 0.3 to 1 mm), Wc (wavelength: 1 to 3 mm), and Wd (wavelength: 3 to 10 mm)] using a wave scan (“Wave-Scan Dual” manufactured by BYK-Gardner). Table 2 shows the results. Regarding to these wave scan values, a smaller Wa means excellence in gloss and a smaller Wd means excellence in surface texture.

### Example 2

A laminated coating film was obtained in the same manner as in Example 1, except that the melamine-curable and water-based base coating material B-2 (whose base resin had a Tg of −10° C.) obtained in Preparation Example 4 was used in place of the water-based base coating material B-1. The obtained laminated coating film was subjected to the determination of Wa to Wd in the same manner as in Example 1. Table 2 shows the results.

### Example 3

A laminated coating film was obtained in the same manner as in Example 1, except that the melamine-curable and water-based base coating material B-3 (whose base resin had a Tg of 0° C.) obtained in Preparation Example 5 was used in place of the water-based base coating material B-1. The obtained laminated coating film was subjected to the determination of Wa to Wd in the same manner as in Example 1. Table 2 shows the results.

### Example 4

A laminated coating film was obtained in the same manner as in Example 1, except that the isocyanate-curable and water-based base coating material B-6 (whose base resin had a Tg of −20° C.) obtained in Preparation Example 8 was used in place of the water-based base coating material B-1. The obtained laminated coating film was subjected to the determination of Wa to Wd in the same manner as in Example 1. Table 2 shows the results.

### Example 5

A laminated coating film was obtained in the same manner as in Example 1, except that the isocyanate-curable and water-based base coating material B-7 (whose base resin had a Tg of −10° C.) obtained in Preparation Example 9 was used in place of the water-based base coating material B-1. The obtained laminated coating film was subjected to the determination of Wa to Wd in the same manner as in Example 1. Table 2 shows the results.

### Example 6

A laminated coating film was obtained in the same manner as in Example 1, except that the isocyanate-curable and water-based base coating material B-8 (whose base resin had a Tg of 0° C.) obtained in Preparation Example 10 was used in place of the water-based base coating material B-1. The obtained laminated coating film was subjected to the determination of Wa to Wd in the same manner as in Example 1. Table 2 shows the results.

### Comparative Example 1

A laminated coating film was obtained in the same manner as in Example 1, except that the melamine-curable and water-based base coating material B-4 (whose base resin had a Tg of 10° C.) obtained in Preparation Example 6 was used in place of the water-based base coating material B-1. The obtained laminated coating film was subjected to the determination of Wa to Wd in the same manner as in Example 1. Table 2 shows the results.

### Comparative Example 2

A laminated coating film was obtained in the same manner as in Example 1, except that the melamine-curable and water-based base coating material B-5 (whose base resin had a Tg of 40° C.) obtained in Preparation Example 7 was used in place of the water-based base coating material B-1. The obtained laminated coating film was subjected to the determination of Wa to Wd in the same manner as in Example 1. Table 2 shows the results.

### Comparative Example 3

A laminated coating film was obtained in the same manner as in Example 1, except that the isocyanate-curable and water-based base coating material B-9 (whose base resin had a Tg of 10° C.) obtained in Preparation Example 11 was used in place of the water-based base coating material B-1. The obtained laminated coating film was subjected to the determination of Wa to Wd in the same manner as in Example 1. Table 2 shows the results.

### Comparative Example 4

A laminated coating film was obtained in the same manner as in Example 1, except that the isocyanate-curable and water-based base coating material B-10 (whose base resin had a Tg of 40° C.) obtained in Preparation Example 12 was used in place of the water-based base coating material B-1. The obtained laminated coating film was subjected to the determination of Wa to Wd in the same manner as in Example 1. Table 2 shows the results.

TABLE 2

| | Tg (° C.) of | | | | |
|---|---|---|---|---|---|
| | base resin in base | | | | |
| | coating material | Wa | Wb | Wc | Wd |
| Ex. 1 | −20 | 10 | 10.1 | 5 | 6.1 |
| Ex. 2 | −10 | 11 | 10.8 | 5.7 | 6.3 |
| Ex. 3 | 0 | 12.9 | 11.5 | 6.9 | 6.7 |
| Ex. 4 | −20 | 8.5 | 9.1 | 5.6 | 6 |
| Ex. 5 | −10 | 9.2 | 9.3 | 6.1 | 6.2 |
| Ex. 6 | 0 | 10.7 | 10.1 | 6.3 | 6.5 |
| Comp. | 10 | 18.3 | 17.2 | 11.2 | 8.1 |
| Ex. 1 | | | | | |
| Comp. | 40 | 25.8 | 27.9 | 14.8 | 8.5 |
| Ex. 2 | | | | | |
| Comp. | 10 | 16.7 | 15.8 | 10.5 | 8 |
| Ex. 3 | | | | | |
| Comp. | 40 | 23.9 | 25.8 | 12.2 | 8.3 |
| Ex. 4 | | | | | |

As apparent from the results shown in Table 2, Wa to Wd of each of the laminated coating films (Examples 1 to 6) were smaller than those of conventional laminated coating films (Comparative Examples 1 to 4). Here, each of the laminated coating films (Examples 1 to 6) was obtained in a wet-on-wet manner by using thermosetting coating materials for the lowermost layer, intermediate layer and uppermost layer, provided that a thermosetting coating material containing a base resin having a glass transition temperature of 5° C. or less was used as one intermediate layer-coating material, in accordance with the present invention. Meanwhile, each of the conventional laminated coating films (Comparative Examples 1 to 4) was obtained by using a thermosetting coating material containing a base resin having a glass transition temperature exceeding 5° C. as the intermediate layer-coating material. Particularly, each of the laminated coating films of Examples 1 to 6 had a Wa value of 15 or less, and was excellent in appearance quality, whereas each of the laminated coating films of Comparative Examples 1 to 4 had a Wa value greater than 15, and was poor in appearance quality.

The comparison within the laminated coating films of Examples 1 to 6 showed that, as the Tg of the base resin contained in the thermosetting coating material for the intermediate layer lowers, the Wa to Wd become smaller, and the appearance quality is more improved. In particular, it was found out that each of the laminated coating films of Examples 1, 4 and 5 had a Wa value of 10 or less, and had extremely excellent appearance quality.

Further, the comparison of the laminated coating films of Examples 1 to 3 with the laminated coating films of Examples 4 to 6 showed that, when an isocyanate-curable and water-based base coating material is used (Examples 4 to 6), the Wa to Wd (particularly Wa) become smaller and the appearance quality is further improved in comparison with the case where a melamine-curable and water-based base coating material was used (Examples 1 to 3). The speculation is that, because the weight loss percentage of an isocyanate-curable and water-based base coating material at 140° C. is smaller than that of a melamine-curable and water-based base coating material, shrinkage of the coating films during the heat treatment is restrained by the use of the isocyanate-curable and water-based base coating materials.

### INDUSTRIAL APPLICABILITY

As has been described above, according to the present invention, even when three or more kinds of coating materials are applied in a wet-on-wet manner and then the layers are baked to cure all the layers, a laminated coating film having the uppermost layer with less surface unevenness can be obtained. This makes it possible to obtain a coated article more excellent in appearance qualities such as surface texture (surface smoothness) and gloss.

Accordingly, the present invention is useful as a coating method capable of obtaining a coated article excellent in appearance quality even in a case where three or more coating materials are applied in a wet-on-wet manner and baked. Particularly, the present invention is useful as a coating method for bodies or components of automobiles such as passenger cars, trucks, buses and motorcycles.

1. A coating method for forming a laminated coating film including a lowermost layer formed on a base material, at least one intermediate layer formed on the lowermost layer, and an uppermost layer formed on the intermediate layer, the coating method comprising the steps of:
preparing a thermosetting coating material as a lowermost layer-coating material for forming the lowermost layer, preparing a thermosetting coating material as an intermediate layer-coating material for forming the intermediate layer, wherein at least one thermosetting coating material for the intermediate layer is a thermosetting coating material containing a base resin having a glass transition temperature of 5° C. or less, and preparing a thermosetting coating material as an uppermost layer-coating material for forming the uppermost layer, wherein the uppermost layer-coating material is a coating material of which a weight loss percentage is measured to be 0.5% by mass or less at a curing temperature of the uppermost layer-coating material,
forming an uncured laminated coating film by applying the lowermost layer-, the intermediate layer- and the uppermost layer-coating materials on the base material in a wet-on-wet manner, and
curing the lowermost layer-, the intermediate layer- and the uppermost layer-coating materials by subjecting the uncured laminated coating film to a heat treatment.

2. (canceled)

3. A coating method for forming a laminated coating film including a lowermost layer formed on a base material, at least one intermediate layer formed on the lowermost layer, and an uppermost layer formed on the intermediate layer, the coating method comprising the steps of:
preparing a thermosetting coating material as a lowermost layer-coating material for forming the lowermost layer, preparing a thermosetting coating material as an intermediate layer-coating material for forming the intermediate layer, wherein at least one thermosetting coating material for the intermediate layer is a thermosetting coating material containing a base resin having a glass transition temperature of 5° C. or less, and preparing a thermosetting coating material as an uppermost layer-coating material for forming the uppermost layer, wherein at least one intermediate layer-coating material is a coating material of which a weight loss percentage is measured to be 0.5% by mass or less at a curing temperature of the uppermost layer-coating material,
forming an uncured laminated coating film by applying the lowermost layer-, the intermediate layer- and the uppermost layer-coating materials on the base material in a wet-on-wet manner, and
curing the lowermost layer-, the intermediate layer- and the uppermost layer-coating materials by subjecting the uncured laminated coating film to a heat treatment.

4. The coating method according to claim 1, wherein
the uncured laminated coating film is subjected to a heat treatment below a temperature lower than a curing temperature of the uppermost layer-coating material by 20° C., and subsequently subjected to a heat treatment at or above the temperature lower than the curing temperature of the uppermost layer-coating material by 20° C.

5. A coated article comprising a laminated coating film including a lowermost layer formed on a base material, at least one intermediate layer formed on the lowermost layer, and an uppermost layer formed on the intermediate layer, wherein the coated article is obtained by the coating method according to claim 1.

6. The coating method according to claim 3, wherein
the uncured laminated coating film is subjected to a heat treatment below a temperature lower than a curing temperature of the uppermost layer-coating material by 20° C., and subsequently subjected to a heat treatment at or above the temperature lower than the curing temperature of the uppermost layer-coating material by 20° C.

7. A coated article comprising a laminated coating film including a lowermost layer formed on a base material, at least one intermediate layer formed on the lowermost layer, and an uppermost layer formed on the intermediate layer, wherein the coated article is obtained by the coating method according to claim 3.
